(19) United States
(12) Patent Application Publication
(10) Pub. No.: US 2005/0063422 A1
(43) Pub. Date: Mar. 24, 2005

(54) Communication protocol over power line communication networks

(76) Inventors: Sashi Lazar, Silver Spring, MD (US); James Fisch, Columbia, MD (US); Christopher L. Reinert, Plano, TX (US); Charles Abraham, Clarksville, MD (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(21) Appl. No.: 10/666,852

(22) Filed: Sep. 19, 2003

(51) Int. Cl. H02J 1/00; H04J 3/04; H01P 5/12

(52) U.S. Cl. 370/532; 307/1; 333/117; 327/407; 709/200

(57) ABSTRACT

A communication apparatus for high-speed data transmission over power line networks comprises a head-end unit which provides a single logical entry point into the communication network, an infrastructure of physical power line cables, one or more client-end units which communicate with the head-end unit, and one or more hybrid units which simultaneously acts as a head-end unit for another physical sub-network of the power line communication network and functions as a client-end unit of another physical sub-network of the power line communication network.

### BACKGROUND OF THE INVENTION

The present invention relates generally to power line communication networks, and more particularly the protocols used for enabling and transmitting various media types and digital data at very high speeds over electrical power lines.

Typically, the power line communication network is composed of two components. The first component is the Wide-Area Power Line Network (WPLN), which is the communication infrastructure that provides transmission of data between the utility substations and the customer premise equipment typically located at, or near by, the electronic power meter. The second component of the power line communication network is the Local Area Power Line Network (LPLN), which is the communication infrastructure located at the customer premise.

All components of the power line communication network provide a bi-directional communication channel. Each channel is a point-to-point link composed of a modulator/demodulator pair (MODEM), which initiates the transmission, a physical medium which transmits the high frequency signal, and a terminating modem which receives the signal. To implement a full duplex channel, each modem may act as a transmitter and a receiver simultaneously.

In a typical configuration, the customer premise equipment includes a device that composed of a modem-pair. This device operates as a client modem of the WPLN communicates with the upstream modem located at the utility substation, as well as a head-unit for communicating with all the end-user equipment located at the customer premise. In essence, this device provides a single point of entry into the customer premise LPLN.

In addition of the physical infrastructure, the power line communication network must provide a resource allocation scheme that defines the policies and procedures for inserting and removing devices into and from the network. These resource allocation schemes are typically based on different policies on the WPLN and the LPLN.

### SUMMARY OF THE INVENTION

Briefly stated, in a first embodiment, the present invention defines the communication infrastructure and protocols that enable high-speed data communication over power line networks. The physical communication infrastructure comprises:
a head-end modem device that provides a single point of entry into the particular power line communication sub-network,
a physical transmission medium, composed of various power lines,
a client-end modem device that directly or indirectly connects customer premise and end user equipment to the power line communication network.

In the second embodiment, the present invention defines the protocols used to establish logical communication between the physical elements defined in the first embodiment:
a protocol that facilitates the insertion of new physical network element into an already existing network,
a protocol that allows resource recovery following the extraction of an active network device from the already existing network,
a protocol that facilitates the reconfiguration of allocated resources among active devices attached to the already existing network.

### BRIEF DESCRIPTION OF THE DRAWINGS

The foregoing summary, as well as the following detailed description of the preferred embodiments of the invention, will be better understood when read in conjunctions with the appended drawings. For the purpose of illustrating the invention, there are shown in the drawings embodiments that are presently preferred. It should be understood, however, that the invention is not limited to the precise arrangement and instrumentalities shown. In the drawings, like numerals are used to indicate like elements throughout. In the drawings:

FIG. 1 is a graphical illustration of the full-duplex communication channel between the head-end unit and various client-end units.

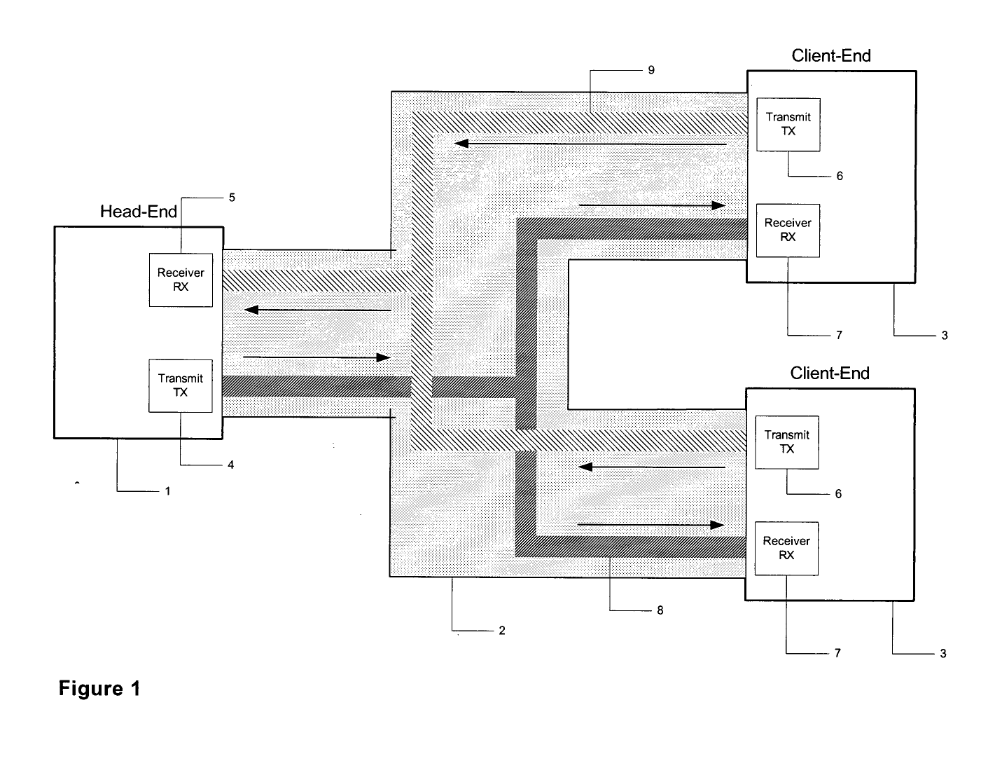

FIG. 2 is a graphical illustration of a hybrid data transmit and receive unit, which functions as a client-end unit on one sub-network and the head-end unit on another.

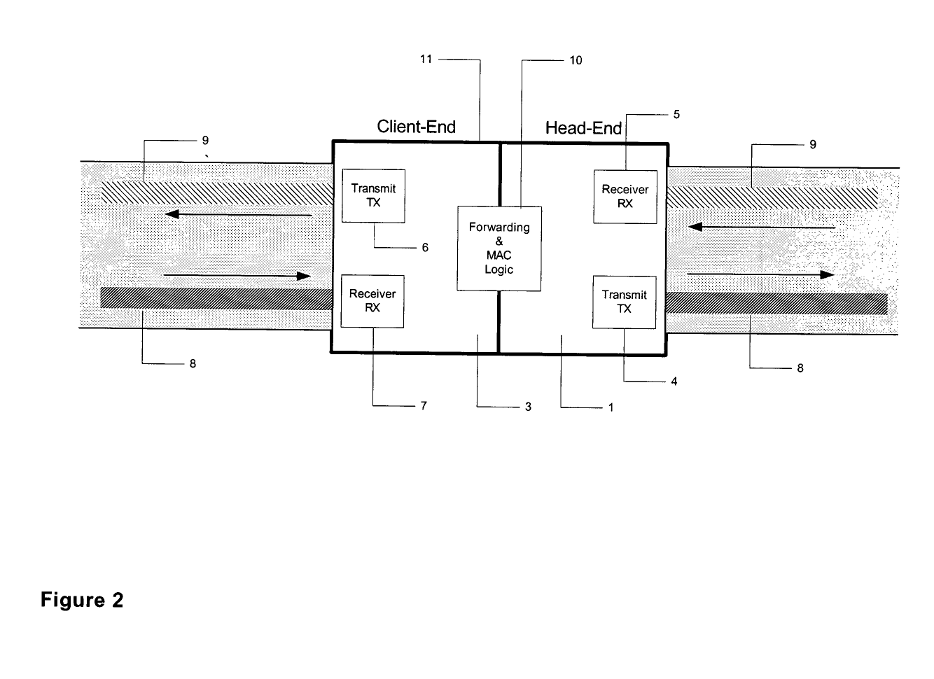

FIG. 3 is a graphical illustration of the time division multiplexing and time slice allocation scheme used in the present invention.

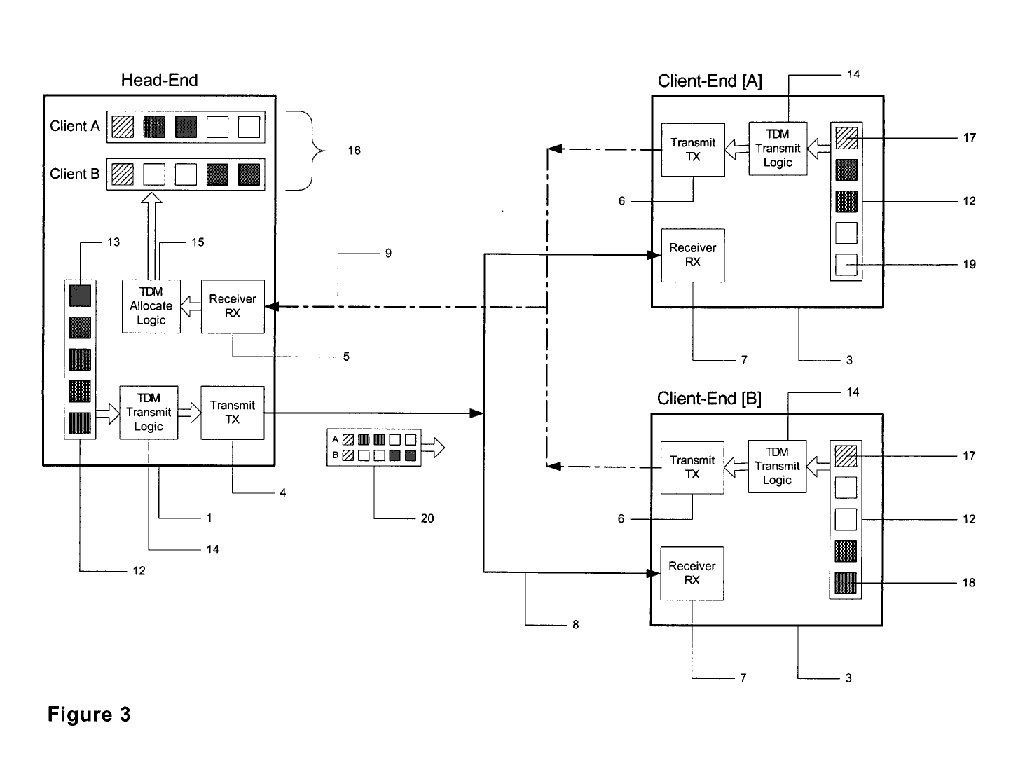

FIG. 4 is a graphical illustration of the protocol transition states for frame reception over the power line communication network.

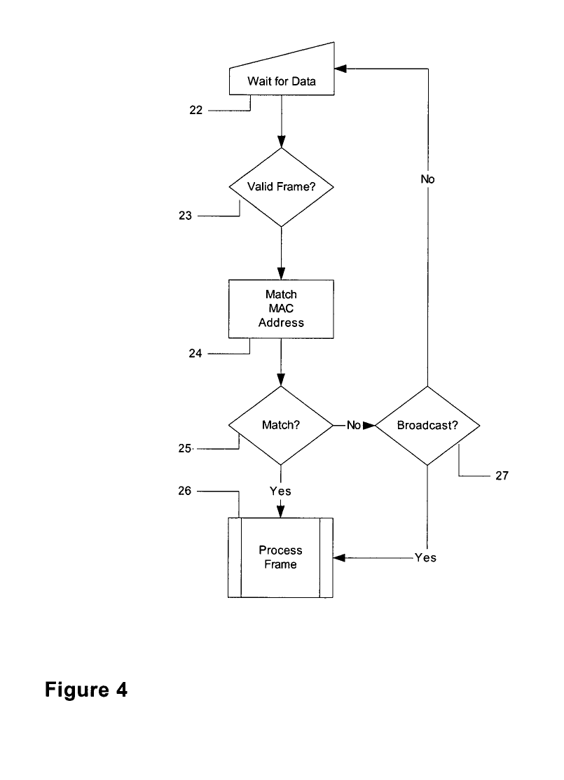

FIG. 5. is a graphical illustration of the protocol transition states for device insertion into the power line communication network.

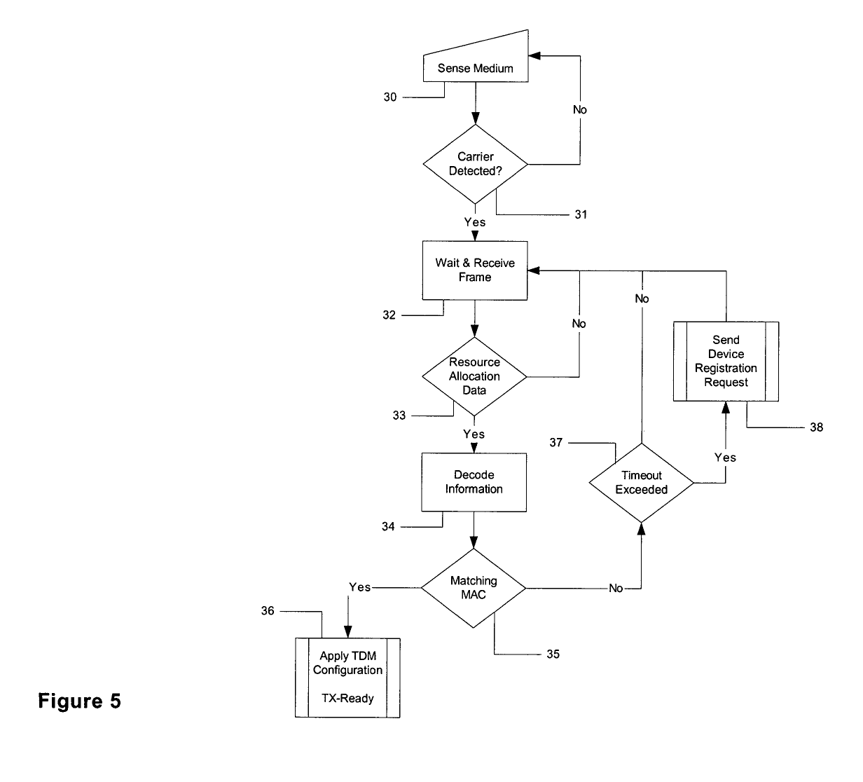

FIG. 6 is a graphical illustration of the protocol transition states of the head-end unit for detecting inactive client-end devices.

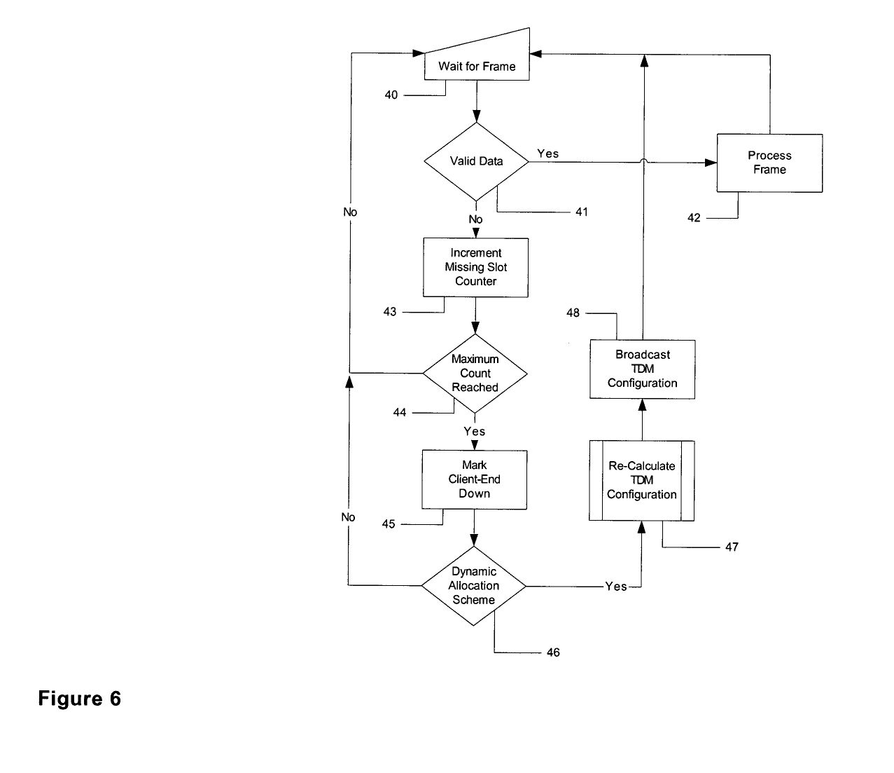

FIG. 7. is a graphical illustration of a typical power line communication network, including illustrations of the most common media applications.

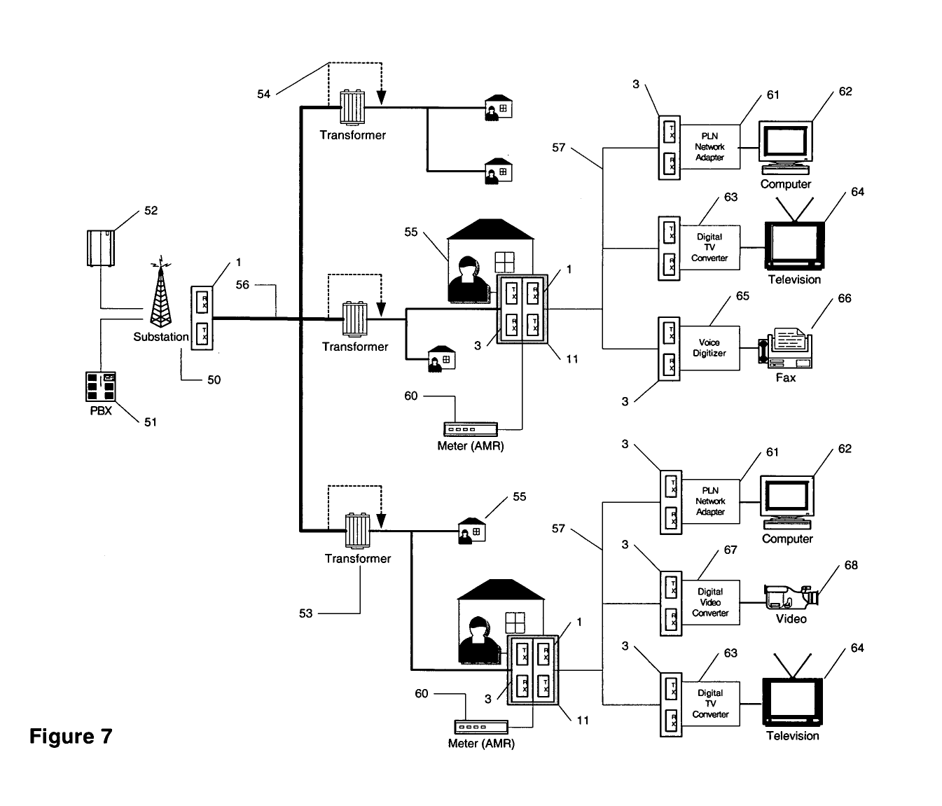

FIG. 8 is a graphical illustration of the frame and packet format used by the power line communication network.

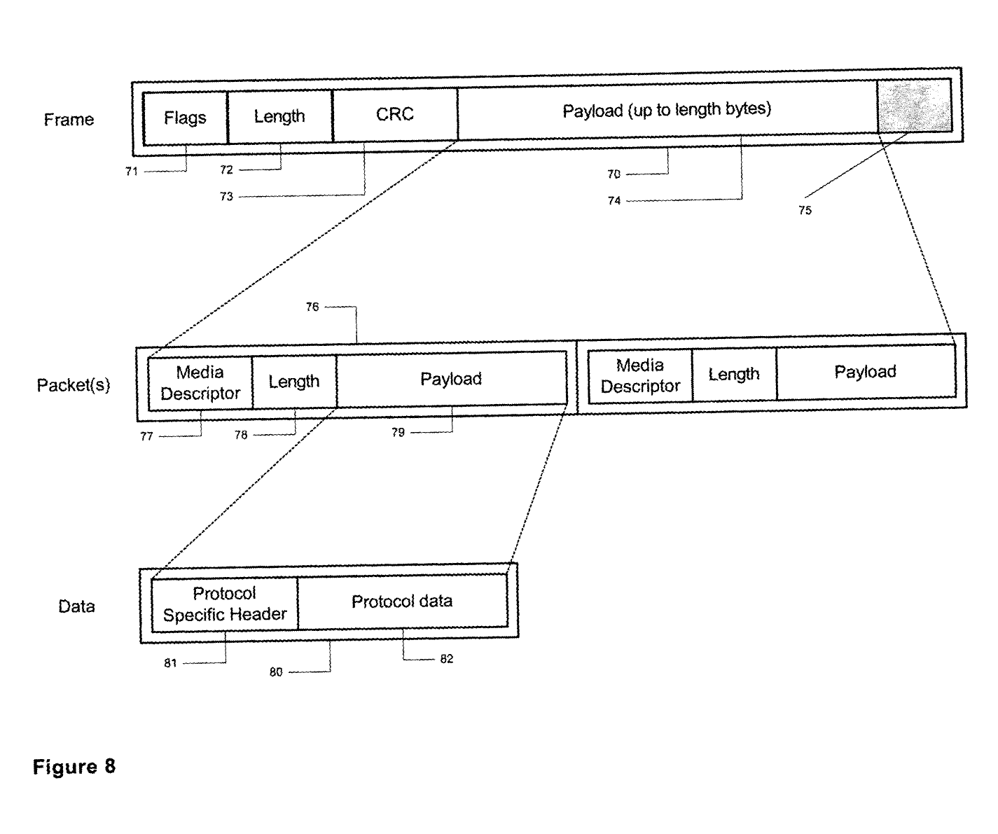

### DETAILED DESCRIPTION OF THE INVENTION

The present invention describes both the physical and logical characteristics of power line communication network, related to high-speed digital data transmission systems.

The physical transmission medium is composed of three basic parts: a transmitter unit 4 that sends modulated digital data across various power lines, the power line grid 2 itself, which provides the transmission medium, and a receiver 7 that demodulates the signal sent by the transmitter. Although the electrical power grid is typically viewed as a shared bus medium, for the purpose of this invention, based on the nature of the transmission and reception rules, the power line communication network is viewed as a point-to-multipoint architecture. At the center of the architecture is the head-end unit 1, which is responsible—among many other things—to supervise the medium access control for the entire sub-network. The head-end unit consists of a pair of transmitter 4 and receiver 5 modules, tuned to different frequency bands, such that the two bands do not overlap, nor they interfere with on another.

In addition to the head-end unit, there is one or more client end units 3 attached to the electrical power line network. Although similar in hardware design, the client-end units act as slave devices to the head-end unit. The client-end units consist of a pair of transmitter 6 and receiver 7 modules, tuned to different frequency bands, such that the two bands do not overlap, nor they interfere with on another.

From a network topology point of view, there is a logical full duplex communication channel between every client-end units and the head-end unit of the PLC network. This logical bi-directional communication path is actually composed by two half-duplex channels, one from the head-end unit to each client-end unit (downstream path) 8, and another from the client-end units to the head-unit (upstream path) 9. These half duplex channels are implemented by tuning the client-end units' receiver module's 7 frequency to the transmit frequency of the head-end unit. Similarly, the head-end unit's receiver module 5 is tuned to the exact same frequency as the transmitter module 6 of the client-end units.

This dual unidirectional configuration has three advantages. First, the total allowable bandwidth in both the downstream and upstream directions are mutually exclusive, unlike typical LAN and WAN environments where all the traffic share the same transmission medium. Therefore the actual total throughput of the PLC network is the sum of the downstream and the upstream communication channel's capacity. Second, given the physical configuration of the network, the downstream communication path is guaranteed to be collision free. This eliminates the need for complex collision detection algorithms. Third, and perhaps most importantly, this frequency division scheme allows multiple head-end units 1 to be placed on the same physical electrical power grid. However, it is important to observe that whereas these head-end units are physically connected to the same electrical grid, their transmit and receive frequency bands are mutually exclusive, therefore they are thought of as two separate sub-network, each with its own set of client-end units. More specifically, since each client-end unit 3 may be tuned to communicate with only one head-end unit 1, it is not possible to receive communication across these two (logically) separate networks. Nevertheless, this property provides virtually limitless bandwidth over the electrical power line grid. As long as the transmit and receive frequencies are mutually exclusive and non-interfering, there are no restrictions on the number of logical sub-networks which can be overlaid on the same physical power line grid.

Since on any given (logical) power line communication network there is only a single head-unit with a single transmitter module, the downstream path is guaranteed to be collision free. The upstream pipe 9, however, is composed of a single receiver 5 with multiple transmitter 6 modules, all tuned to the same transmit frequency. If not carefully synchronized, one client-end unit's transmission can collide with other transmissions by other client-end units. To avoid collision on the upstream direction, the total transmission bandwidth is divided into several smaller time slices 13. Each time slice has an equal transmit bandwidth and may be assigned to no more than one client-end unit at a time. Being assigned one or more time-slices permits the client-end units to transmit in the upstream direction. The allocation scheme by which client-end units are assigned their individual time slots varies based on the network environment. In WPLC network, time slot resources are typically assigned based on a pre-defined subscription rate. Since each time slot guarantees a minimum constant bit rate (CBR) service, time slot allocation of wide are networks are based on the amount of premium paid by each end user. In local area networks, where most of the devices are under the same administrative domain, unless they belong to a different class of service, bandwidth allocation is typically based on an “equal share” policy. In contrast to the subscription based policy, where time slot allocation is static, this scheme uses a dynamic allocation algorithm, in which resources are (re)calculated and (re)assigned each time a new device is inserted into the network, or an existing devices is deactivated.

Whereas the time slot based transmission scheme can provide collision free communication for all client-end devices 3 registered with the head-end unit 1, the insertion of new devices, which do not yet have resources allocated to them, pose a challenge because these devices have not received any time slot allocation, and therefore—by the rules of the protocol—are not allowed to transmit data. To facilitate new devices to register with the head-end unit, one ore more time slices may be reserved by the network explicitly for new device registration. It is worth noting here, that this time slot is not meant to be mutually exclusive, and therefore prone to occasional collisions, when one or more client-end devices send their registration information to the head-end unit at the same time. However, random timeout and backup algorithms can be used to minimize collisions among new client-end units.

The protocol for new device insertion is as follows:
the client-end device continuously monitors the transmission medium, waiting for carrier detection 31;
when carrier has been detected, the client-end unit waits for any medium access control (MAC) supervisory packet 32, which contains the broadcasted time slot allocations 20 for all known client-end units;
upon receiving a MAC supervisory packet, the new client-end unit searches 34 the time slot allocation table for a record that matches its hardware address 35;
if this record is located, the client-end unit incorporates the time slot allocation record into its memory, and may begin transmitting data in the upstream direction 36;
otherwise, if the received MAC supervisory packet does not contain a matching time slot allocation record, the client-unit passively returns to waiting for new MAC supervisory packets 32, unless the pre-configured timeout expires 37, in which case
the client-end unit sends a registration message 38 to the head-end unit over the reserved registration time slots, and passively returns to waiting 32 for new MAC supervisory frames.

It is worth noting here, that the head-end unit may elect to deny the registration request from the client-end unit. This is an implicit denial of service, as the head-end unit does not send an acknowledgement downstream to the requesting client-end device. It simply does not include a new allocation record in the table of broadcasted time slot allocations.

When a dynamic time slot allocation scheme is used, it is important for the head-end unit to detect when one or more client-end units have been deactivated, so the previously allocated time slot resources can be re-assigned to other, active, client-end units. The protocol logic for detecting inactive client-end units is as follows:
for each upstream time slot, the head-end unit examines the received frame to determine if the transmission contained any valid data 41 (note that client-end units transmit empty frames during all their assigned time-slots, even when they have no actual data to transmit);
if the time slot did not contain a valid frame, the missing slot counter is incremented 43 for the client-end device to which the time slot was assigned;
if the maximum missing slot count has been exceeded, the head-end unit marks the client-end unit as “down” 45, and the client-end unit's resource allocation record is removed 47 from the time slot allocation table broadcasted 48 downstream by the head-end unit;
if possible, the previously allocated time slots are assigned to other, currently active, client-end units.

It is imperative to the correct operation of this scheme that all client-end devices use to most up-to-date time slot allocation scheme sent by the head-end unit. Every client-end device must be ready to receive and update its time allocation information based on the MAC supervisory packets broadcasted downstream from the head-end unit. The protocol for re-configuring the local time slot allocation information for each client-end unit is as follows:
the client-end device is continuously waiting for valid frames;
if the frame contains any MAC supervisory information, the client-end unit searches the time allocation table contained in the supervisory frame for a record that matches its own hardware address,
if no record was found, the client end device must immediately cease transmission, and enter into a reset state,
otherwise, the time slot allocation record is applied immediately to the client-end unit's local configuration.

The lowest unit of the digital transmission is a frame 70. The maximum frame size is defined by the bandwidth of each time slot allocated to every client-end unit. The frame is composed of:
a flags field 71 that contains various MAC level control information,
a length field 72 that specified the number of valid octets in the payload,
a cyclic redundancy check (CRC) field 73 that contains the CRC block calculated over the payload block before transmission,
a payload 74, and possibly
some unused frame bytes 75.

The payload of each frame contains one or more packets 76. The packet format is defined as follows:
a media descriptor field 77 that is used to classify the type of packet,
a length field 78, which is the number of octets following that should be considered as part of the packet's payload 79.

Typically, the packet payloads 80 contain a protocol specific header 81 and data 82.

The media descriptor field contains information about the type of protocol that was used at the UNI (user to network interface) to form the packet. This allows various forwarding hardware to provide a better quality of service based of the content type carried in the payload. For example, one of the pre-defined media descriptor value is used to indicate a MAC supervisory packet.

The advantage of using this format is that it allows the power line communication network to carry a virtually limitless set of media formats. These include, but not limited to, Internet Protocol (IP) data, automatic meter reading (AMR) information, digitized voice and phone services, digital television signal, digital video and surveillance streams.

To support one or more of these media service types, the head-end unit located at the power line substation 50 is connected to a service provider's uplink. The type of the uplink and the protocol used solely depends on the service type being supported. For example, for IP networks, the substation would typically be equipped with a high-speed fiber data uplink 52, such as SONET or Gigabit-Ethernet. Similarly, to support digital phone and voice communication systems, the substation must include a digital interface to a PBX or SS7 switch 51.

The signal from these uplinks is transmitted over the power line grid 56 from the head-end unit to the client-end units located at each residential or commercial end-user's premises 55. It is worth noting here, that the signals are passed through 54 any transformer 53 located between the substation and the customer premise equipment (CPE) without regeneration. The CPE is actually a hybrid PLC network element 11, which functions as a client-end unit 3 toward the substation, and a head-end unit 1 for the local area network 57 inside of the customer premise.

The local area network at the customer premise consists of a single head-end unit 1, which is typically co-located with the power meter and an optional automatic meter reading (AMR) device 60, and one or more client-end units 3. The client-units contain media-based adapters which enable a large variety of hardware to communicate over the power line communication network. For example, the PLN network adapter 61 allows personal computers 62 (PCs) to be connected to the PLC network. Other adapters may include:
digital television converters 63, which allow the reception of high-quality digital TV or cable service 64,
voice digitizer and phone interface 65, which provides digital quality voice communication 66,
video adapters 67, which allow cameras and other surveillance devices 68 to use the power line communication network.

Changes can be made to the embodiments described above without departing from the broad inventive concept thereof. The present invention is thus not limited to the particular embodiments disclosed, but is intended to cover modifications within the spirit and scope of the present invention.

1. A communication apparatus for high-speed data transmission over power line networks comprises:
a head-end unit which provides a single logical entry point into the communication network;
an infrastructure of physical power line cables;
one or more client-end units which communicate with the head-end unit;
one or more hybrid units which simultaneously:
acts as a head-end unit for another physical sub-network of the power line communication network, and
functions as a client-end unit of another physical sub-network of the power line communication network;

2. All physical devices on the power line network are assigned a globally unique hardware address.

3. The logical full-duplex communication channel between the head-end and client-end units is comprised of:
a logical half-duplex downstream communication channel, in which the modulator frequency of the head-end unit's transmitter is matched by the demodulator frequency of the every client-end unit associated with the head-end unit on the same physical power line sub-network, and a logical half-duplex upstream communication channel, in which the modulator frequency of each client-end unit is matched with the demodulator frequency of the head-end unit;

4. The downstream and upstream frequency channels are mutually exclusive.

5. The bandwidth of the downstream communication channel may be identical or different from the bandwidth of the upstream communication channel;

6. The bandwidth between the head-end unit and client-end units with matching frequency pairs is defined by the sum of:
the bandwidth of the frequency band of the downstream channel, plus
the bandwidth of the frequency band of the upstream channel;

7. To increase the total capacity of the power line network, multiple frequency pairs may be overlaid on the same transmission medium, such that:
all downstream frequency bands are mutually exclusive and non-interfering,
all upstream frequency bands are mutually exclusive and non-interfering,
all full-duplex communication frequency bands are mutually exclusive and non-interfering.

8. The bandwidth of each half-duplex communication channel between the head-end unit and one or more client-end units is divided into one or more transmission time slots, such that:
all time slots are assigned equal bandwidth,
all time slots are sequentially numbered starting from 0,
the bandwidth of each time slot defines the maximum data size and burst rate any node can transmit at any given time.

9. The total bandwidth of each half-duplex communication channel is defined as the product of the bandwidth of each time slot and the total number of time slots.

10. A device on any given physical sub-network of the power line communication network may transmit data only if:
its carrier sensing sub-system positively detected a valid carrier (head-end units are excluded from this restriction), and
its time allocation resource map permits data transmission at the given time slot.

11. The head-end unit broadcasts all downstream data to all client-end units on the same logical sub-network.

12. The head-end unit in this communication apparatus defined in claim 1:
may transmit data at any given time slot,
is responsible for generating the resource allocation maps for each registered client-end unit,
is responsible for registering new client-end units,
is responsible for detecting inactive and extracted client-end units.

13. Client-end units perform frame selection/discard locally, in parallel, based on the following algorithm:
each client-end unit must examine the destination hardware address of the data frame received from the head-unit, and
if the destination hardware address matches with its own hardware address, the frame is scheduled for processing,
otherwise the frame is discarded.

14. A client-end unit may transmit data if, and only if:
it has received its time slot allocation map from the head-end unit, and
its time slot allocation map permits data transmission at the given time.

15. Time slots on the upstream channel are assigned to be mutually exclusive for all client-end units. This guarantees that the upstream traffic is collision free.

16. One or more time slots are reserved to allow new devices (which have not been assigned any resources) to send registration information to the head-unit.

17. The medium access control sub-system for the communication apparatus in claim 1, must comply with the following algorithms:
new client-end devices to be inserted into the active network must:
passively monitor the resource allocation and time slot configuration periodically broadcasted by the head-end unit, and
if the received configuration contains a valid time slot allocation for the given client-end device, this information must be applied immediately, and the client-end device may begin to transmit upstream data at the allowed time slots;
otherwise, if after a configurable timeout period, the client device does not receive any configuration containing a valid time slot allocation for the given client-end device, the client-end device may send a registration request over the reserved time slot in claim 16.
devices that are to be extracted from the power line communication network may:
send an explicit un-registration request to the head-end unit over any time slot currently assigned to the client-end device, or
terminate communication without sending an explicit un-registration request to the head-end unit.
all active client-end devices on the power line communication network must:
continuously monitor downstream traffic for time slot allocation updates from the head-end unit, and
incorporate any configuration change immediately after reception.
any active client-end device on the power line communication network must:
continuously monitor downstream traffic for explicit termination messages from the head-end unit, and
discontinue all transmission and enter its initialization phase immediately after reception or this message.

18. Time slot resources may be assigned either:
a prescription based allocation scheme, where:
the amount of bandwidth allocated to an individual client-end unit is based on a pre-defined subscription rate, plus
any unused resources not subscribed to may be temporarily allocated to active subscribers with the following constraints:
the additional bandwidth may be revoked at any time, without notice by the head-end unit,
the total allowable throughput of the client-end device may not exceed the sum of the subscribed and temporary allocated bandwidth.
an evenly distributed bandwidth allocation scheme, where:
every client-end device receives an equal share of the total time allocation resources,
time allocation resources are dynamically assigned,
a dynamically assigned un-even resource allocation scheme, where:
every client-end device receives a time slot allocation based on a pre-set resource allocation algorithms,
time allocation resources are dynamically assigned,

19. The protocol frame format is designed to allow virtually any type of payload to be carried across the power line communication network.

20. The protocol frame format is composed of (but not limited to) the following required fields:
a length field, which identifies the number of octets in the payload of the frame,
a media selector field, which identifies the type of payload,
a cyclic redundancy check (CRC) field, which contains the CRC value calculated over the reaming portion of the frame,
an arbitrary sequence of data, which represents the payload of the frame.

21. The communication apparatus in claim 1 over the power line network is currently designed (but not limited to) for supporting the following applications:
internet data for local, medium, and wide area networks, including but not limited to:
ethernet (IEEE 802.3) frame forwarding,
wireless LAN (IEEE 802.11) frame forwarding,
internet protocol (IP) packet forwarding, address translation, and packet filtering, token bus (IEEE 802.4) frame forwarding,
token ring (IEEE 802.5) frame forwarding,
telephone and digital voice packet forwarding, and SS-7 digital signaling interface message forwarding and processing,
digital video transmission frame forwarding and processing,
digital television and cable service data forwarding, command message relay, and processing,
automatic meter reading (AMR) message forwarding and processing.
